(19) United States
(12) Patent Application Publication
(10) Pub. No.: US 2023/0125621 A1
(43) Pub. Date: Apr. 27, 2023

(54) GENERATING VISUALIZATIONS FOR SEMI-STRUCTURED DATA

(71) Applicant: International Business Machines Corporation, Armonk, NY (US)

(72) Inventors: Wen Pei Yu, Xi'an (CN); Ji Hui Yang, Beijing (CN); Xiao Ming Ma, Xi'an (CN); Rui Wang, Xi'an (CN); Jing James Xu, Xi'an (CN)

(21) Appl. No.: 17/509,269

(22) Filed: Oct. 25, 2021

(51) Int. Cl. G06K 9/62; G06F 16/84; G06N 20/00

(52) U.S. Cl. CPC G06K 9/6256; G06F 16/84; G06N 20/00

(57) ABSTRACT

A computer-implemented method, system and computer program product for generating visualizations for semi-structured data. Visualization data is extracted from infographics depicting semi-structured data. The visualization data that is extracted includes the traits or characteristics of the semi-structured data depicted in the infographics (e.g., dimension), the characteristics of the infographics (e.g., location of the depicted data), and the constraints or display requirements (e.g., display target value in a particular axis). A trait and constraint rule set is then generated based on the extracted visualization data. The trait and constraint rule set includes a set of rules that maps the display requirements to the particular set of traits or characteristics exhibited by the semi-structured data displayed in the infographics. A model is then trained to map the semi-structured data to elements of the infographics using the trait and constraint rule set and the characteristics of the infographics using association rule learning.

### TECHNICAL FIELD

The present disclosure relates generally to automated machine learning, and more particularly to generating visualizations for semi-structured data.

### BACKGROUND

Automated machine learning (AutoML) is the process of automating the time-consuming, iterative tasks of machine learning model development. It allows data scientists, analysts, and developers to build ML models with high scale, efficiency, and productivity all while sustaining model quality. Furthermore, the high degree of automation in AutoML allows non-experts to make use of machine learning models and techniques without requiring them to become experts in machine learning. Automating the process of applying machine learning end-to-end additionally offers the advantages of producing simpler solutions, faster creation of those solutions, and models that often outperform hand-designed models. AutoML has been used to compare the relative importance of each factor in a prediction model.

### SUMMARY

In one embodiment of the present disclosure, a computer-implemented method for generating visualizations for semi-structured data comprises extracting visualization data from infographics, where the visualization data comprises the following: traits of a first set of semi-structured data displayed in the infographics, characteristics of the infographics and constraints in displaying the first set of semi-structured data in the infographics. The method further comprises generating a trait and constraint rule set from the extracted visualization data, where the trait and constraint rule set comprises the traits of the first set of semi-structured data and constraints in displaying the first set of semi-structured data in the infographics. The method additionally comprises training a model to map semi-structured data to elements of infographics using the trait and constraint rule set and the characteristics of the infographics using association rule learning.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the visualization generator to generate visualizations for semi-structured data in accordance with an embodiment of the present disclosure;

FIG. 3 illustrates an exemplary infographic for visualizing semi-structured data based on a trait and constraint rule in accordance with an embodiment of the present disclosure;

FIG. 4 illustrates an embodiment of the present disclosure of the hardware configuration of the visualization generator which is representative of a hardware environment for practicing the present disclosure;

FIG. 5 is a flowchart of a method for training a model for mapping semi-structured data to elements of the infographics in accordance with an embodiment of the present disclosure;

FIG. 6 is a flowchart of a method for refining the model predictions for mapping semi-structured data to elements of the infographics in accordance with an embodiment of the present disclosure; and

FIG. 7 is a flowchart of a method for generating visualizations for semi-structured data in accordance with an embodiment of the present disclosure.

### DETAILED DESCRIPTION

As stated in the Background section, automated machine learning (AutoML) is the process of automating the time-consuming, iterative tasks of machine learning model development. It allows data scientists, analysts, and developers to build MlL models with high scale, efficiency, and productivity all while sustaining model quality. Furthermore, the high degree of automation in AutoML allows non-experts to make use of machine learning models and techniques without requiring them to become experts in machine learning. Automating the process of applying machine learning end-to-end additionally offers the advantages of producing simpler solutions, faster creation of those solutions, and models that often outperform hand-designed models. AutoML has been used to compare the relative importance of each factor in a prediction model.

Automated machine learning algorithms produce lots of statistical data in the form of semi-structured data, such as JavaScript® Object Notation (JSON), extensible markup language (XML), log files, etc. Such semi-structured data contains lots of information, such as details about the algorithm, model selection, accuracy of output of the algorithms, etc. Semi-structured data is a form of structured data that does not obey the tabular structure of data models associated with relational databases or other forms of data tables, but nonetheless contains tags or other markers to separate semantic elements and enforce hierarchies of records and fields within the data.

Often, users desire to visualize such data (semi-structured data) so as to more easily understand the data as well as identify trends and outliers. However, current visualization engines have difficulty in visualizing such semi-structured data because it needs to parse the semi-structured data one by one. Furthermore, in the attempt to visualize such data, some of the statistical or model information may be lost.

As a result, there is not currently a means for effectively visualizing semi-structured data, such as semi-structured data produced by automated machine learning algorithms.

The embodiments of the present disclosure provide a means for effectively visualizing semi-structured data, such as semi-structured data produced by automated machine learning algorithms, by training a model to map semi-structured data to elements of the infographics using a trait and constraint rule set using association rule learning.

In some embodiments of the present disclosure, the present disclosure comprises a computer-implemented method, system and computer program product for generating visualizations for semi-structured data. In one embodiment of the present disclosure, visualization data is extracted from infographics depicting semi-structured data. “Infographics,” as used herein, refer to a visual image, such as a chart or diagram, used to represent information or data. In one embodiment, the visualization data that is extracted includes the traits or characteristics of the semi-structured data depicted in the infographics (e.g., data, label, label type, dimension, data type, distribution, range, etc.), the characteristics of the infographics (e.g., type, location and style of the depicted data), and the constraints or display requirements (e.g., display target value in a particular axis). A trait and constraint rule set is then generated based on the extracted visualization data. A “trait and constraint rule set,” as used herein, refers to a set of rules that maps the display requirements (constraints) to the particular set of traits or characteristics exhibited by the semi-structured data displayed in the infographics. For example, a trait and constraint rule may indicate the particular location, style, etc. to depict the semi-structured data on a particular infographic for semi-structured data with traits that match the traits in the trait and constraint rule. A model is then trained to map the semi-structured data to elements of the infographics using the trait and constraint rule set and the characteristics of the infographics using association rule learning. In this manner, semi-structured data, such as semi-structured data produced by automated machine learning algorithms, is effectively visualized.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

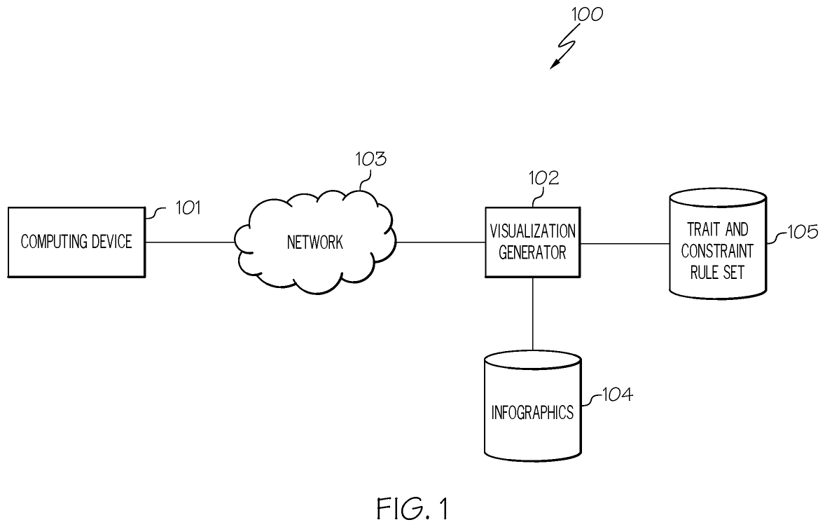

Referring now to the Figures in detail, FIG. 1 illustrates an embodiment of the present disclosure of a communication system 100 for practicing the principles of the present disclosure. Communication system 100 includes a computing device 101 connected to a visualization generator 102 via a network 103.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and visualization generator 102. It is noted that both computing device 101 and the user of computing device 101 may be identified with element number 101.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, computing device 101 engages in automated machine learning in which the automated machine learning algorithm produces statistical data in the form of semi-structured data, such as JavaScript® Object Notation (JSON), extensible markup language (XML), log files, etc. Such semi-structured data contains lots of information, such as details about the algorithm, model selection, accuracy of output of the algorithms, etc. Semi-structured data is a form of structured data that does not obey the tabular structure of data models associated with relational databases or other forms of data tables, but nonetheless contains tags or other markers to separate semantic elements and enforce hierarchies of records and fields within the data.

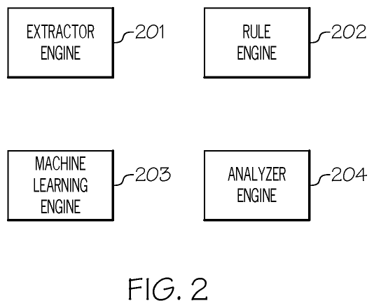

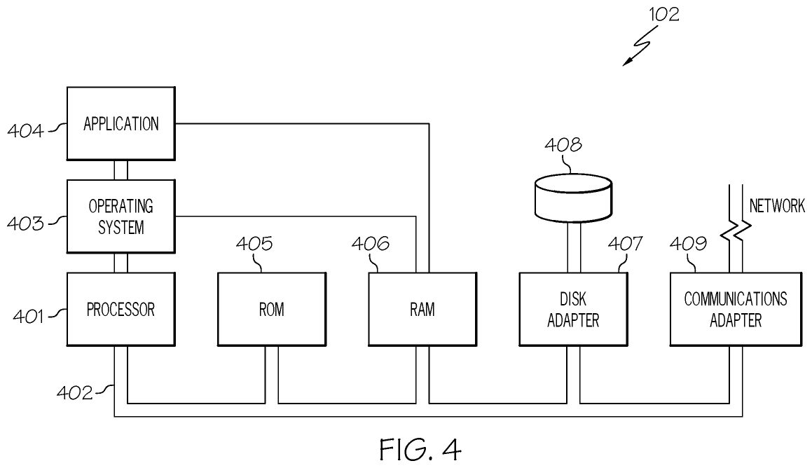

In one embodiment, visualization generator 102 is configured to generate visualizations for such semi-structured data. In one embodiment, such visualizations are generated based on training a model to map semi-structured data to elements of the infographics using the trait and constraint rule set and the characteristics of the infographics using association rule learning. “Infographics,” as used herein, refer to a visual image, such as a chart or diagram, used to represent information or data. “Elements,” as used herein, refer to the components (e.g., y-axis, row in a table) of the infographics. A “trait and constraint rule set,” as used herein, refers to a set of rules that maps the display requirements (constraints) to the particular set of traits or characteristics exhibited by the semi-structured data displayed in the infographics. “Traits,” as used herein, may be used interchangeably with the term “characteristics.” Furthermore, “constraints,” as used herein, refer to the display requirements for the traits or characteristics. “Association rule learning,” as used herein, refers to a rule-based machine learning method for discovering interesting relations between variables, such as between the traits or characteristics of the semi-structured data and the display requirements or constraints for such traits or characteristics. A more detailed description of these and other features will be provided below. Furthermore, a description of the software components of visualization generator 102 is provided below in connection with FIG. 2 and a description of the hardware configuration of visualization generator 102 is provided further below in connection with FIG. 4.

In one embodiment, the infographics that are used to train the model to map semi-structured data to elements of the infographics is stored in a database 104 connected to visualization generator 102. In one embodiment, the trait and constraint rule set used to train the model to map semi-structured data to elements of the infographics is stored in a database 105 connected to visualization generator 102. While FIG. 1 illustrates two separate databases 104, 105 to store infographics and the trait and constraint rule set, a single database may be utilized to store such information.

System 100 is not to be limited in scope to any one particular network architecture. System 100 may include any number of computing devices 101, visualization generators 102, networks 103 and databases 104, 105.

A discussion regarding the software components used by visualization generator 102 to generate visualizations for semi-structured data is provided below in connection with FIG. 2.

FIG. 2 is a diagram of the software components of visualization generator 102 (FIG. 1) to generate visualizations for semi-structured data in accordance with an embodiment of the present disclosure.

Referring to FIG. 2, in conjunction with FIG. 1, visualization generator 102 includes an extractor engine 201. Extractor engine 201 is configured to extract visualization data from infographics, such as the infographics that are stored in database 104. Such extracted visualization data is used to train a model to generate visualizations for semi-structured data as discussed further below.

In one embodiment, such visualization data that is extracted by extractor engine 201 includes the traits or characteristics of the semi-structured data depicted in the infographics, the characteristics of the infographics, and the constraints or display requirements. For example, the traits or characteristics of the semi-structured data may include the data (e.g., matrix data), label, label type (e.g., string), dimension (e.g., one-dimensional array, two-dimensional array, N*N structure, N*M structure), data type (e.g., floating), distribution (e.g., normal, uniform), range of data (e.g., 0 to 1), etc. In another example, the characteristics of the infographics may include the type (e.g., table, chart) of infographic, location and style of the depicted data, etc. In another example, the constraints or display requirements may include the requirements for displaying a particular value, such as the target value (e.g., y-axis, a particular row in a table).

In one embodiment, such visualization data is obtained by extractor engine 201 extracting HyperText Markup Language (HTML) data, scalable vector graphics (SVG) information, Canvas information and configuration data from the infographics. A discussion regarding extractor engine 201 extracting such information is discussed below.

In one embodiment, extractor engine 201 extracts HyperText Markup Language (HTML) data (e.g., content structured as a data table) via an HTML extractor, such as using one of the following software tools: Safe Software® HTMLExtractor, HTML Text Extractor by Iconico®, HTML Extractor by npm, HTML Extractor by Rust, etc. In one embodiment, such HTML data may include the traits or characteristics of the semi-structured data, such as data (e.g., matrix data), label, label type (e.g., string), dimension (e.g., one-dimensional array, two-dimensional array, N*N structure, N*M structure), data type (e.g., floating), distribution (e.g., normal, uniform), range of data (e.g., 0 to 1), etc.

In one embodiment, extractor engine 201 extracts scalable vector graphics (SVG) or Canvas information via an SVG/Canvas extractor It is noted that the symbol “/,” as used herein, means “or.” Hence, “SVG/Canvas extractor” refers to a SVG extractor or a Canvas extractor. In one embodiment, such SVG or Canvas information includes characteristics of the infographics (e.g., type, location and style of the depicted data) and the constraints or display requirements (e.g., requirements for displaying a particular value).

SVG corresponds to an XML-based image format that is used to define two-dimensional vector-based graphics. Canvas, on the other hand, draws two-dimensional graphics on the fly via scripting (e.g., JavaScript®). Software tools utilized by extractor engine 201 to extract SVG information include, but not limited to, the SVG extractor by npm, Extractor SVG Vector by SVG Repo, SVG-Inline-File-Extractor by RubyGems, etc. Furthermore, software tools utilized by extractor engine 201 to extract Canvas information include, but not limited to, Graph Data Extractor by SourceForge®, WebPlotDigitizer, Canvas Extractor by Apache®, etc.

Additionally, in one embodiment, extractor engine 201 extracts configuration data pertaining to the configuration or arrangement of the semi-structured data on the infographics using software tools, such as WebPlotDigitizer, Engauge Digitizer, etc. Such configuration data may be used to determine the constraints or the display requirements, such as displaying the target value in a particular axis (e.g., y-axis) or in a particular row in a table.

Such information extracted by extractor engine 201 may be utilized by a rule engine 202 of visualization generator 102 to generate a trait and constraint rule set as discussed below.

In one embodiment, rule engine 202 is configured to generate the trait and constraint rule set from the extracted visualization data. The “trait and constraint rule set,” as used herein, refers to a set of rules that maps the display requirements (constraints) to the particular set of traits or characteristics exhibited by the semi-structured data displayed in the infographics.

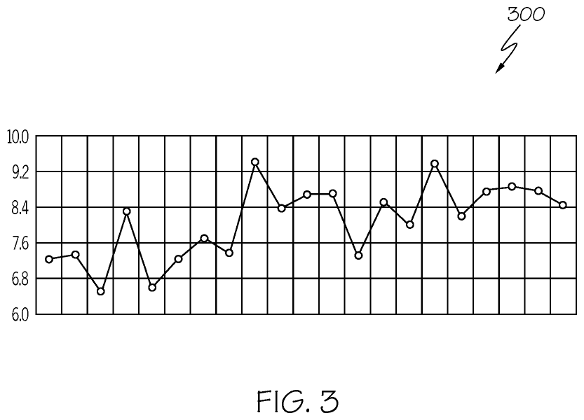

In one embodiment, the trait and constraint rule set includes a combination of trait and constraint rules. In one embodiment, each trait and constraint rule includes the traits or characteristics of specific semi-structured data and the constraints in displaying such semi-structured data. For example, each trait and constraint rule includes one or more of the following information: an identifier, a range of data, such as the accuracy range (e.g., 0 to 1), a distribution, a dimension (e.g., one-dimensional array, two-dimensional array, N*N structure, N*M structure), and constraints (e.g., target value displayed on Y-axis). Each trait and constraint rule is associated with a particular manner of visualizing the semi-structural data (with traits that match the traits in the trait and constraint rule) at particular locations, with particular styles, etc. on a particular type of infographic (e.g., graph, table). For example, the trait and constraint rule may include the semi-structured data traits of a range of greater than 1, a normal distribution and an N*M array, which is displayed in a graph (visualization associated with such a trait and constraint rule) at particular locations as shown in FIG. 3.

FIG. 3 illustrates an exemplary chart 300 associated with visualizing semi-structured data with the trait and constraint rule indicating a range of greater than 1, a normal distribution and an N*M array in accordance with an embodiment of the present disclosure.

Returning to FIG. 2, in conjunction with FIGS. 1 and 3, in one embodiment, rule engine 202 generates the trait and constraint rule set by generating rules based on the visualization data extracted from particular infographics by extractor engine 201. As previously discussed, the extracted visualization data includes the traits or characteristics of the semi-structured data depicted in the infographics, the characteristics of the infographics, and the constraints or display requirements. Such information is used by rule engine 202 to form a rule (trait and constraint rule) in the trait and constraint rule set.

In one embodiment, rule engine 202 generates such a trait and constraint rule set from the extracted visualization data using various software tools including, but not limited to, Drools®, IBM® Operational Decision Manager, InterSystems® IRIS Data Platform, etc.

Visualization generator 102 additionally includes a machine learning engine 203 configured to train a model to map the semi-structured data to elements of the infographics using the trait and constraint rule set and the characteristics of the infographics using association rule learning.

In one embodiment, machine learning engine 203 maps the rule (trait and constraint rule) to a type of visualization (e.g., graph, table) to display the semi-structured data based on the constraints or display requirements listed in the trait and constraint rule which contains the traits or characteristics (e.g., range of greater than 1, normal distribution, N*M array) of the semi-structured data. In one embodiment, such mapping may be accomplished via a score (referred to herein as the “visualization score”) which is associated with a particular type of infographic (e.g., table, chart) that is utilized to visualize the semi-structured data according to the constraints listed in the trait and constraint rule. In one embodiment, such visualization scores along with the associated trait and constraint rules and the associated types of infographics are stored in a data structure (e.g., table). For example, trait and constraint rule #A is associated with visualization score 1, which is associated with the infographic type of a chart. In one embodiment, such a data structure is populated by an expert. In one embodiment, such a data structure is stored in a storage device (e.g., memory, disk unit) of visualization generator 102.

In one embodiment, the mapping of such a rule to a type of visualization is based on the infographics upon which the visualization data was extracted. For example, if the extracted visualization data includes semi-structured data in the range of greater than 1, a normal distribution, and an N*M array, and such visualization data was extracted from a chart, then the trait and constraint rule populated with such visualization data is associated with an infographic in the form of a chart.

In one embodiment, machine learning engine 203 uses a machine learning algorithm (e.g., supervised learning) to build a mathematical model based on sample data consisting of the trait and constraint rule set and the associated infographics (characteristics of such infographics) collected from rule engine 202. Such a data set is referred to herein as the “training data” which is used by the machine learning algorithm to make predictions or decisions without being explicitly programmed to perform the task. In one embodiment, the training data consists of semi-structured data with various traits and characteristics found in the trait and constraint rules. The algorithm iteratively makes predictions on the training data as to the visualization (infographic) and the locations within the visualization to depict the semi-structured data (as well as the styles, etc.) with such various traits and characteristics based on the sample data consisting of the trait and constraint rule set and the associated infographics. Examples of such supervised learning algorithms include nearest neighbor, Naive Bayes, decision trees, linear regression, support vector machines and neural networks.

In one embodiment, the mathematical model (machine learning model) corresponds to a classification model trained to predict the visualization (infographic) to depict the semi-structured data with such various traits and characteristics.

As discussed above, in one embodiment, machine learning engine 203 trains a model to map the semi-structured data to elements of the infographics using the trait and constraint rule set and the characteristics of the infographics using the association rule learning. “Association rule learning,” as used herein, refers to a rule-based machine learning method for discovering interesting relations between variables, such as between the traits or characteristics of the semi-structured data and the display requirements or constraints for such traits or characteristics. In one embodiment, examples of such association rule learning algorithms utilized by machine learning engine 203 for discovering interesting relations between variables, include, but not limited to, Apriori algorithm, Eclat algorithm, FP-growth algorithm, ASSOC procedure, etc.

In one embodiment, such association rule learning algorithms are utilized to analyze the semi-structured data (e.g., JSON) to generate a rule pertaining to a statistical item. For example, a rule may be generated indicating that statistical item A corresponds to accuracy. In another example, a rule may be generated indicating that statistical item B corresponds to R-square.

In one embodiment, such a model generates a value (referred to herein as the “visualization score”) that is associated with a particular infographic (e.g., chart, table) to be utilized to display or visualize the semi-structured data, where such a value (visualization score) is associated with a trait and constraint rule that includes the traits or characteristics of such semi-structured data and where the semi-structured data is depicted in such a visualization (particular infographic) according to the constraints listed in such a trait and constraint rule.

In one embodiment, feedback is provided by a user (e.g., user of computing device 101) based on the visualizations identified by the trained model, where such visualizations are identified by the trained model via the visualization scores generated by the model. Such feedback may include a recommendation to utilize a different infographic for the semi-structured data. As a result, based on such feedback, the trait and constraint rule (e.g., rule in the rule set) may be updated so that it is associated with a different infographic. Furthermore, as a result, the visualization score associated with the trait and constraint rule will be updated so that it is associated with a different infographic.

Furthermore, in one embodiment, machine learning engine 203 generates a confusion matrix to provide a summary of the prediction results from the model trained to map the semi-structured data to elements of the infographics. A confusion matrix, as used herein, refers to a technique for summarizing the prediction results of the model. In one embodiment, such a confusion matrix is a specific table layout that allows the visualization of the performance of an algorithm, such as a supervised learning algorithm, to build a mathematical model. In one embodiment, each row of the matrix represents the instances in an actual class while each column represents the instances in a predicted class, or vice-versa.

In one embodiment, machine learning engine 203 calculates the confusion matrix by making a prediction for each row in the test dataset (predictions of visualization for semi-structured data). From the expected outcomes and predictions, machine learning engine 203 counts the number of correct predictions for each class and the number of incorrect predictions for each class, organized by the class that was predicted. These numbers are then organized into a table or matrix, such as follows: each row of the matrix corresponds to a predicted class and each column of the matrix corresponds to an actual class. The counts of correct and incorrect classifications are then filled into the table. The total number of correct predictions for a class are entered into the expected row for that class value and the predicted column for that class value. In the same way, the total number of incorrect predictions for a class are entered into the expected row for that class value and the predicted column for that class value.

Additionally, visualization generator 102 includes an analyzer engine 204 configured to analyze the semi-structured data to identify the traits or characteristics of the semi-structured data, such as the data (e.g., matrix data), label, label type (e.g., string), dimension (e.g., one-dimensional array, two-dimensional array, N*N structure, N*M structure), data type (e.g., floating), distribution (e.g., normal, uniform), range of data (e.g., 0 to 1), etc.

Software tools utilized by analyzer engine 204 to analyze the semi-structured data to identify the characteristics of the semi-structured data, include, but not limited to, Infrrd®, Import.io®, Altair® Monarch, OutWit Hub, etc.

In one embodiment, once such characteristics are identified by analyzer engine 204, machine learning engine 203, using the model, identifies the appropriate trait and constraint rule from the trait and constraint rule set that most closely matches the characteristics identified by analyzer engine 204.

In one embodiment, machine learning engine 203 utilizes natural language processing to determine how closely such characteristics match the characteristics in the trait and constraint rules in the trait and constraint rule set. For example, if the characteristics of the analyzed semi-structured data include an accuracy range of 0 and 0.5, a normal distribution, and a M*N array, then such characteristics are searched in the trait and constraint rules in the trait and constraint rule set for a rule that most closely matches such characteristics.

In one embodiment, algorithms used by machine learning engine 203 to perform such natural language processing include, but not limited to, support vector machines, Bayesian networks, maximum entropy, conditional random field, neural networks, etc.

In one embodiment, machine learning engine 203 utilizes fuzzy string searching to determine how closely such characteristics match the characteristics in the trait and constraint rules in the trait and constraint rule set.

In one embodiment, after identifying the trait and constraint rule from the trait and constraint rule set, a visualization score is generated using the trained model as discussed above.

A further description of these and other functions is provided below in connection with the discussion of the method for generating visualizations for semi-structured data.

Prior to the discussion of the method for generating visualizations for semi-structured data, a description of the hardware configuration of visualization generator 102 (FIG. 1) is provided below in connection with FIG. 4.

Referring now to FIG. 4, FIG. 4 illustrates an embodiment of the present disclosure of the hardware configuration of visualization generator 102 (FIG. 1) which is representative of a hardware environment for practicing the present disclosure.

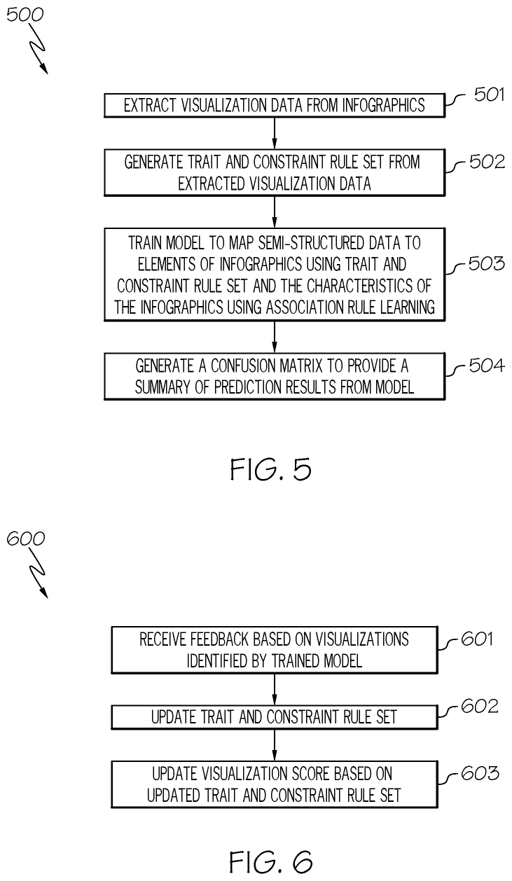

Visualization generator 102 has a processor 401 connected to various other components by system bus 402. An operating system 403 runs on processor 401 and provides control and coordinates the functions of the various components of FIG. 4. An application 404 in accordance with the principles of the present disclosure runs in conjunction with operating system 403 and provides calls to operating system 403 where the calls implement the various functions or services to be performed by application 404. Application 404 may include, for example, extractor engine 201 (FIG. 2), rule engine 202 (FIG. 2), machine learning engine 203 (FIG. 2) and analyzer engine 204 (FIG. 2). Furthermore, application 404 may include, for example, a program for generating visualizations for semi-structured data as discussed further below in connection with FIGS. 5-7.

Referring again to FIG. 4, read-only memory (“ROM”) 405 is connected to system bus 402 and includes a basic input/output system (“BIOS”) that controls certain basic functions of visualization generator 102. Random access memory (“RAM”) 406 and disk adapter 407 are also connected to system bus 402. It should be noted that software components including operating system 403 and application 404 may be loaded into RAM 406, which may be visualization generator's 102 main memory for execution. Disk adapter 407 may be an integrated drive electronics (“IDE”) adapter that communicates with a disk unit 408, e.g., disk drive. It is noted that the program for generating visualizations for semi-structured data, as discussed further below in connection with FIGS. 5-7, may reside in disk unit 408 or in application 404.

Visualization generator 102 may further include a communications adapter 409 connected to bus 402. Communications adapter 409 interconnects bus 402 with an outside network (e.g., network 103 of FIG. 1) to communicate with other devices, such as computing device 101 (FIG. 1).

In one embodiment, application 404 of visualization generator 102 includes the software components of extractor engine 201, rule engine 202, machine learning engine 203 and analyzer engine 204. In one embodiment, such components may be implemented in hardware, where such hardware components would be connected to bus 402. The functions discussed above performed by such components are not generic computer functions. As a result, visualization generator 102 is a particular machine that is the result of implementing specific, non-generic computer functions.

In one embodiment, the functionality of such software components (e.g., extractor engine 201, rule engine 202, machine learning engine 203 and analyzer engine 204) of visualization generator 102, including the functionality for generating visualizations for semi-structured data, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, automated machine learning (AutoML) is the process of automating the time-consuming, iterative tasks of machine learning model development. It allows data scientists, analysts, and developers to build ML models with high scale, efficiency, and productivity all while sustaining model quality. Furthermore, the high degree of automation in AutoML allows non-experts to make use of machine learning models and techniques without requiring them to become experts in machine learning. Automating the process of applying machine learning end-to-end additionally offers the advantages of producing simpler solutions, faster creation of those solutions, and models that often outperform hand-designed models. AutoML has been used to compare the relative importance of each factor in a prediction model. Automated machine learning algorithms produce lots of statistical data in the form of semi-structured data, such as JavaScript® Object Notation (JSON), extensible markup language (XML), log files, etc. Such semi-structured data contains lots of information, such as details about the algorithm, model selection, accuracy of output of the algorithms, etc. Semi-structured data is a form of structured data that does not obey the tabular structure of data models associated with relational databases or other forms of data tables, but nonetheless contains tags or other markers to separate semantic elements and enforce hierarchies of records and fields within the data. Often, users desire to visualize such data (semi-structured data) so as to more easily understand the data as well as identify trends and outliers. However, current visualization engines have difficulty in visualizing such semi-structured data because it needs to parse the semi-structured data one by one. Furthermore, in the attempt to visualize such data, some of the statistical or model information may be lost. As a result, there is not currently a means for effectively visualizing semi-structured data, such as semi-structured data produced by automated machine learning algorithms.

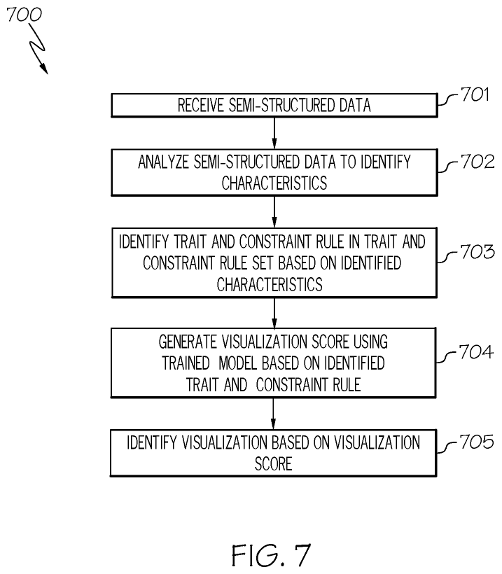

The embodiments of the present disclosure provide a means for effectively visualizing semi-structured data, such as semi-structured data produced by automated machine learning algorithms, by training a model to map semi-structured data to elements of the infographics using a trait and constraint rule set using association rule learning as discussed below in connection with FIGS. 5-7. FIG. 5 is a flowchart of a method for training a model for mapping semi-structured data to elements of the infographics. FIG. 6 is a flowchart of a method for refining the model predictions for mapping semi-structured data to elements of the infographics. FIG. 7 is a flowchart of a method for generating visualizations for semi-structured data.

As stated above, FIG. 5 is a flowchart of a method 500 for training a model for mapping semi-structured data to elements of the infographics in accordance with an embodiment of the present disclosure.

Referring to FIG. 5, in conjunction with FIGS. 1-4, in operation 501, extractor engine 201 of visualization generator 102 extracts visualization data from infographics, such as the infographics that are stored in database 104. Such extracted visualization data is used to train a model to generate visualizations for semi-structured data.

As state above, “infographics,” as used herein, refer to a visual image, such as a chart or diagram, used to represent information or data.

Furthermore, as discussed above, in one embodiment, visualization data that is extracted by extractor engine 201 includes the traits or characteristics of the semi-structured data depicted in the infographics, the characteristics of the infographics, and the constraints or display requirements. For example, the traits or characteristics of the semi-structured data may include the data (e.g., matrix data), label, label type (e.g., string), dimension (e.g., one-dimensional array, two-dimensional array, N*N structure, N*M structure), data type (e.g., floating), distribution (e.g., normal, uniform), range of data (e.g., 0 to 1), etc. In another example, the characteristics of the infographics may include the type (e.g., table, chart) of infographic, location and style of the depicted data, etc. In another example, the constraints or display requirements may include the requirements for displaying a particular value, such as the target value (e.g., y-axis, a particular row in a table).

In one embodiment, such visualization data is obtained by extractor engine 201 extracting HyperText Markup Language (HTML) data, scalable vector graphics (SVG) information, Canvas information and configuration data from the infographics.

In one embodiment, extractor engine 201 extracts HyperText Markup Language (HTML) data (e.g., content structured as a data table) via an HTML extractor, such as using one of the following software tools: Safe Software® HTMLExtractor, HTML Text Extractor by Iconico®, HTML Extractor by npm, HTML Extractor by Rust, etc. In one embodiment, such HTML data may include the traits or characteristics of the semi-structured data, such as data (e.g., matrix data), label, label type (e.g., string), dimension (e.g., one-dimensional array, two-dimensional array, N*N structure, N*M structure), data type (e.g., floating), distribution (e.g., normal, uniform), range of data (e.g., 0 to 1), etc.

In one embodiment, extractor engine 201 extracts scalable vector graphics (SVG) or Canvas information via an SVG/Canvas extractor It is noted that the symbol “/,” as used herein, means “or.” Hence, “SVG/Canvas extractor” refers to a SVG extractor or a Canvas extractor. In one embodiment, such SVG or Canvas information includes characteristics of the infographics (e.g., type, location and style of the depicted data) and the constraints or display requirements (e.g., requirements for displaying a particular value).

As previously discussed, SVG corresponds to an XML-based image format that is used to define two-dimensional vector-based graphics. Canvas, on the other hand, draws two-dimensional graphics on the fly via scripting (e.g., JavaScript®). Software tools utilized by extractor engine 201 to extract SVG information include, but not limited to, the SVG extractor by npm, Extractor SVG Vector by SVG Repo, SVG-Inline-File-Extractor by RubyGems, etc. Furthermore, software tools utilized by extractor engine 201 to extract Canvas information include, but not limited to, Graph Data Extractor by SourceForge®, WebPlotDigitizer, Canvas Extractor by Apache®, etc.

Additionally, in one embodiment, extractor engine 201 extracts configuration data pertaining to the configuration or arrangement of the semi-structured data on the infographics using software tools, such as WebPlotDigitizer, Engauge Digitizer, etc. Such configuration data may be used to determine the constraints or the display requirements, such as displaying the target value in a particular axis (e.g., y-axis) or in a particular row in a table.

In operation 502, rule engine 202 of visualization generator 102 generates the trait and constraint rule set from the extracted visualization data.

As discussed above, the “trait and constraint rule set,” as used herein, refers to a set of rules that maps the display requirements (constraints) to the particular set of traits or characteristics exhibited by the semi-structured data displayed in the infographics.

In one embodiment, the trait and constraint rule set includes a combination of trait and constraint rules. In one embodiment, each trait and constraint rule includes the traits or characteristics of specific semi-structured data and the constraints in displaying such semi-structured data. For example, each trait and constraint rule includes one or more of the following information: an identifier, a range of data, such as the accuracy range (e.g., 0 to 1), a distribution, a dimension (e.g., one-dimensional array, two-dimensional array, N*N structure, N*M structure), and constraints (e.g., target value displayed on Y-axis). Each trait and constraint rule is associated with a particular manner of visualizing the semi-structural data (with traits that match the traits in the trait and constraint rule) at particular locations, with particular styles, etc. on a particular type of infographic (e.g., graph, table). For example, the trait and constraint rule may include the semi-structured data traits of a range of greater than 1, a normal distribution and an N*M array, which is displayed in a graph (visualization associated with such a trait and constraint rule) at particular locations as shown in FIG. 3.

In one embodiment, rule engine 202 generates the trait and constraint rule set by generating rules based on the visualization data extracted from particular infographics by extractor engine 201. As previously discussed, the extracted visualization data includes the traits or characteristics of the semi-structured data depicted in the infographics, the characteristics of the infographics, and the constraints or display requirements. Such information is used by rule engine 202 to form a rule (trait and constraint rule) in the trait and constraint rule set.

In one embodiment, rule engine 202 generates such a trait and constraint rule set from the extracted visualization data using various software tools including, but not limited to, Drools®, IBM® Operational Decision Manager, InterSystems® IRIS Data Platform, etc.

In operation 503, machine learning engine 203 of visualization generator 102 trains a model to map the semi-structured data to elements of infographics using the trait and constraint rule set and the characteristics of the infographics using association rule learning.

As stated above, in one embodiment, machine learning engine 203 maps the rule (trait and constraint rule) to a type of visualization (e.g., graph, table) to display the semi-structured data based on the constraints or display requirements listed in the trait and constraint rule which contains the traits or characteristics (e.g., range of greater than 1, normal distribution, N*M array) of the semi-structured data. In one embodiment, such mapping may be accomplished via a score (referred to herein as the “visualization score”) which is associated with a particular type of infographic (e.g., table, chart) that is utilized to visualize the semi-structured data according to the constraints listed in the trait and constraint rule. In one embodiment, such visualization scores along with the associated trait and constraint rules and the associated types of infographics are stored in a data structure (e.g., table). For example, trait and constraint rule #A is associated with visualization score 1, which is associated with the infographic type of a chart. In one embodiment, such a data structure is populated by an expert. In one embodiment, such a data structure is stored in a storage device (e.g., memory 405, disk unit 408) of visualization generator 102.

In one embodiment, the mapping of such a rule to a type of visualization is based on the infographics upon which the visualization data was extracted. For example, if the extracted visualization data includes semi-structured data in the range of greater than 1, a normal distribution, and an N*M array, and such visualization data was extracted from a chart, then the trait and constraint rule populated with such visualization data is associated with an infographic in the form of a chart.

Furthermore, as discussed above, in one embodiment, machine learning engine 203 uses a machine learning algorithm (e.g., supervised learning) to build a mathematical model based on sample data consisting of the trait and constraint rule set and the associated infographics (characteristics of such infographics) collected from rule engine 202. Such a data set is referred to herein as the “training data” which is used by the machine learning algorithm to make predictions or decisions without being explicitly programmed to perform the task. In one embodiment, the training data consists of semi-structured data with various traits and characteristics found in the trait and constraint rules. The algorithm iteratively makes predictions on the training data as to the visualization (infographic) and the locations within the visualization to depict the semi-structured data (as well as the styles, etc.) with such various traits and characteristics based on the sample data consisting of the trait and constraint rule set and the associated infographics. Examples of such supervised learning algorithms include nearest neighbor, Naive Bayes, decision trees, linear regression, support vector machines and neural networks.

In one embodiment, the mathematical model (machine learning model) corresponds to a classification model trained to predict the visualization (infographic) to depict the semi-structured data with such various traits and characteristics.

As discussed above, in one embodiment, machine learning engine 203 trains a model to map the semi-structured data to elements of the infographics using the trait and constraint rule set and the characteristics of the infographics using the association rule learning. “Association rule learning,” as used herein, refers to a rule-based machine learning method for discovering interesting relations between variables, such as between the traits or characteristics of the semi-structured data and the display requirements or constraints for such traits or characteristics. In one embodiment, examples of such association rule learning algorithms utilized by machine learning engine 203 for discovering interesting relations between variables, include, but not limited to, Apriori algorithm, Eclat algorithm, FP-growth algorithm, ASSOC procedure, etc.

In one embodiment, such association rule learning algorithms are utilized to analyze the semi-structured data (e.g., JSON) to generate a rule pertaining to a statistical item. For example, a rule may be generated indicating that statistical item A corresponds to accuracy. In another example, a rule may be generated indicating that statistical item B corresponds to R-square.

In one embodiment, such a model generates a value (referred to herein as the “visualization score”) that is associated with a particular infographic (e.g., chart, table) to be utilized to display or visualize the semi-structured data, where such a value (visualization score) is associated with a trait and constraint rule that includes the traits or characteristics of such semi-structured data and where the semi-structured data is depicted in such a visualization (particular infographic) according to the constraints listed in such a trait and constraint rule.

In operation 504, machine learning engine 203 of visualization generator 102 generates a confusion matrix to provide a summary of the prediction results from the model.

As discussed above, in one embodiment, machine learning engine 203 generates a confusion matrix to provide a summary of the prediction results from the model trained to map the semi-structured data to elements of the infographics. A confusion matrix, as used herein, refers to a technique for summarizing the prediction results of the model. In one embodiment, such a confusion matrix is a specific table layout that allows the visualization of the performance of an algorithm, such as a supervised learning algorithm, to build a mathematical model. In one embodiment, each row of the matrix represents the instances in an actual class while each column represents the instances in a predicted class, or vice-versa.

In one embodiment, machine learning engine 203 calculates the confusion matrix by making a prediction for each row in the test dataset (predictions of visualization for semi-structured data). From the expected outcomes and predictions, machine learning engine 203 counts the number of correct predictions for each class and the number of incorrect predictions for each class, organized by the class that was predicted. These numbers are then organized into a table or matrix, such as follows: each row of the matrix corresponds to a predicted class and each column of the matrix corresponds to an actual class. The counts of correct and incorrect classifications are then filled into the table. The total number of correct predictions for a class are entered into the expected row for that class value and the predicted column for that class value. In the same way, the total number of incorrect predictions for a class are entered into the expected row for that class value and the predicted column for that class value.

In one embodiment, such a model may improve the accuracy in its generation of visualizations for semi-structured data based on feedback as discussed below in connection with FIG. 6.

FIG. 6 is a flowchart of a method 600 for refining the model predictions for mapping semi-structured data to elements of the infographics in accordance with an embodiment of the present disclosure.

Referring to FIG. 6, in conjunction with FIGS. 1-5, in operation 601, machine learning engine 203 of visualization generator 102 receives feedback based on the visualizations identified by the model, such as via the visualization scores generated by the model. For example, such feedback may be provided by a user (e.g., user of computing device 101) based on the visualizations identified by the trained model. Such feedback may include a recommendation to utilize a different infographic for the semi-structured data.

In operation 602, machine learning engine 203 of visualization generator 102 updates the trait and constraint rule set. For example, as discussed above, the feedback may include a recommendation to utilize a different infographic for the semi-structured data. As a result, based on such feedback, the trait and constraint rule set (e.g., rule in the rule set) may be updated so that it is associated with a different infographic.

In operation 603, machine learning engine 203 of visualization generator 102 updates the visualization score based on the updated trait and constraint rule set. For example, as discussed above, based on feedback, the trait and constraint rule (e.g., rule in the rule set) may be updated so that it is associated with a different infographic. As a result, the visualization score associated with the trait and constraint rule will be updated so that it is associated with a different infographic.

Upon training a model to map semi-structured data to elements of the infographics, such a model may be utilized to generate visualizations for semi-structured data as discussed below in connection with FIG. 7.

FIG. 7 is a flowchart of a method 700 for generating visualizations for semi-structured data in accordance with an embodiment of the present disclosure.

Referring to FIG. 7, in conjunction with FIGS. 1-6, in operation 701, visualization generator 102 receives semi-structured data (e.g., JSON, XML, log files), such as from computing device 101. In one embodiment, computing device 101 engages in automated machine learning in which the automated machine learning algorithm produces statistical data in the form of such semi-structured data.

In operation 702, analyzer engine 204 of visualization generator 102 analyzes the semi-structured data to identify the traits or characteristics of the semi-structured data, such as the data (e.g., matrix data), label, label type (e.g., string), dimension (e.g., one-dimensional array, two-dimensional array, N*N structure, N*M structure), data type (e.g., floating), distribution (e.g., normal, uniform), range of data (e.g., 0 to 1), etc.

As discussed above, software tools utilized by analyzer engine 204 to analyze the semi-structured data to identify the characteristics of the semi-structured data, include, but not limited to, Infrrd®, Import.io®, Altair® Monarch, OutWit Hub, etc.

In operation 703, machine learning engine 203 of visualization generator 102, using the trained model, identifies a trait and constraint rule in the trait and constraint rule set based on the identified characteristics.

As stated above, in one embodiment, machine learning engine 203, using the model, identifies the appropriate trait and constraint rule from the trait and constraint rule set that most closely matches the characteristics identified by analyzer engine 204.

In one embodiment, machine learning engine 203 utilizes natural language processing to determine how closely such characteristics match the characteristics in the trait and constraint rules in the trait and constraint rule set. For example, if the characteristics of the analyzed semi-structured data include an accuracy of 0 and 0.5, a normal distribution, and a M*N array, then such characteristics are searched in the trait and constraint rules in the trait and constraint rule set for a rule that most closely matches such characteristics.

In one embodiment, algorithms used by machine learning engine 203 to perform such natural language processing include, but not limited to, support vector machines, Bayesian networks, maximum entropy, conditional random field, neural networks, etc.

In one embodiment, machine learning engine 203 utilizes fuzzy string searching to determine how closely such characteristics match the characteristics in the trait and constraint rules in the trait and constraint rule set.

In operation 704, machine learning engine 203 of visualization generator 102 generates a visualization score using the trained model based on the identified trait and constraint rule.

As discussed above, the model is trained to map the semi-structured data to elements of infographics using the trait and constraint rule using the association rule learning. In one embodiment, the particular infographic that is utilized to display the semi-structured data is based on the visualization score associated with the trait and constraint rule, such as the trait and constraint rule identified by machine learning engine 203 in operation 703.

As previously discussed, machine learning engine 203 maps such a rule (trait and constraint rule) to a type of visualization (e.g., graph, table) to display the semi-structured data based on the constraints or display requirements listed in the trait and constraint rule which contains the traits or characteristics (e.g., range of greater than 1, normal distribution, N*M array) of the semi-structured data. In one embodiment, such mapping may be accomplished via a score (referred to herein as the “visualization score”) which is associated with a particular type of infographic (e.g., table, chart) that is utilized to visualize the semi-structured data according to the constraints listed in the trait and constraint rule. In one embodiment, such visualization scores along with the associated trait and constraint rules and the associated types of infographics are stored in a data structure (e.g., table). For example, trait and constraint rule #A is associated with visualization score 1, which is associated with the infographic type of a chart.

Upon identifying the type of infographic, the model generates such a visualization of the infographic for the semi-structured data that includes the placement and style of the semi-structured data at various locations within the infographic using the traits or characteristics of the semi-structured data and the constraints listed in the identified trait and constraint rule (identified in operation 703).

In operation 705, machine learning engine 203 of visualization generator 102 identifies the visualization (infographic) based on the visualization score using the data structure discussed above in which the visualization score is associated with a visualization. Upon identifying the visualization, in one embodiment, machine learning engine 203 includes the placement and style of the received semi-structured data at various locations within the identified visualization based on the constraints (display requirements) listed in the identified trait and constraint rule.

In one embodiment, when the semi-structured data is provided from an iterative model, such a visualization may include multiple infographics displaying changes in the semi-structured data produced during the iterations of the iterative model.

In one embodiment, when the semi-structured data is provided from a single model, such a visualization may include a pre-defined order of visualized infographics.

As a result of the foregoing, embodiments of the present disclosure provide a means for effectively visualizing semi-structured data, such as semi-structured data produced by automated machine learning algorithms, by training a model to map semi-structured data to elements of the infographics using a trait and constraint rule set using association rule learning.

Furthermore, the principles of the present disclosure improve the technology or technical field involving automated machine learning. As discussed above, automated machine learning (AutoML) is the process of automating the time-consuming, iterative tasks of machine learning model development. It allows data scientists, analysts, and developers to build ML models with high scale, efficiency, and productivity all while sustaining model quality. Furthermore, the high degree of automation in AutoML allows non-experts to make use of machine learning models and techniques without requiring them to become experts in machine learning. Automating the process of applying machine learning end-to-end additionally offers the advantages of producing simpler solutions, faster creation of those solutions, and models that often outperform hand-designed models. AutoML has been used to compare the relative importance of each factor in a prediction model. Automated machine learning algorithms produce lots of statistical data in the form of semi-structured data, such as JavaScript® Object Notation (JSON), extensible markup language (XML), log files, etc. Such semi-structured data contains lots of information, such as details about the algorithm, model selection, accuracy of output of the algorithms, etc. Semi-structured data is a form of structured data that does not obey the tabular structure of data models associated with relational databases or other forms of data tables, but nonetheless contains tags or other markers to separate semantic elements and enforce hierarchies of records and fields within the data. Often, users desire to visualize such data (semi-structured data) so as to more easily understand the data as well as identify trends and outliers. However, current visualization engines have difficulty in visualizing such semi-structured data because it needs to parse the semi-structured data one by one. Furthermore, in the attempt to visualize such data, some of the statistical or model information may be lost. As a result, there is not currently a means for effectively visualizing semi-structured data, such as semi-structured data produced by automated machine learning algorithms.

Embodiments of the present disclosure improve such technology by extracting visualization data from infographics depicting semi-structured data. “Infographics,” as used herein, refer to a visual image, such as a chart or diagram, used to represent information or data. In one embodiment, the visualization data that is extracted includes the traits or characteristics of the semi-structured data depicted in the infographics (e.g., data, label, label type, dimension, data type, distribution, range, etc.), the characteristics of the infographics (e.g., type, location and style of the depicted data), and the constraints or display requirements (e.g., display target value in a particular axis). A trait and constraint rule set is then generated based on the extracted visualization data. A “trait and constraint rule set,” as used herein, refers to a set of rules that maps the display requirements (constraints) to the particular set of traits or characteristics exhibited by the semi-structured data displayed in the infographics. For example, a trait and constraint rule may indicate the particular location, style, etc. to depict the semi-structured data on a particular infographic for semi-structured data with traits that match the traits in the trait and constraint rule. A model is then trained to map the semi-structured data to elements of the infographics using the trait and constraint rule set and the characteristics of the infographics using association rule learning. In this manner, semi-structured data, such as semi-structured data produced by automated machine learning algorithms, is effectively visualized. Furthermore, in this manner, there is an improvement in the technical field involving automated machine learning.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for generating visualizations for semi-structured data, the method comprising:
extracting visualization data from infographics, wherein said visualization data comprises the following: traits of a first set of semi-structured data displayed in said infographics, characteristics of said infographics and constraints in displaying said first set of semi-structured data in said infographics;
generating a trait and constraint rule set from said extracted visualization data, wherein said trait and constraint rule set comprises said traits of said first set of semi-structured data and said constraints in displaying said first set of semi-structured data in said infographics; and
training a model to map semi-structured data to elements of infographics using said trait and constraint rule set and said characteristics of said infographics using association rule learning.

2. The method as recited in claim 1, wherein said traits of said first set of semi-structured data comprise one or more of the following selected from the group consisting of: a label, a label type, a dimension, a data type, a distribution, and a range of data.

3. The method as recited in claim 1 further comprising:
generating a confusion matrix to provide a summary of prediction results from said model.

4. The method as recited in claim 1 further comprising:
receiving a second set of semi-structured data;
analyzing said second set of semi-structured data to identify characteristics of said second set of semi-structured data;
identifying a trait and constraint rule in said trait and constraint rule set based on said identified characteristics of said second set of semi-structured data;
generating a visualization score using said trained model based on said identified trait and constraint rule; and
identifying a visualization based on said visualization score.

5. The method as recited in claim 4, wherein said visualization comprises a pre-defined order of visualized infographics.

6. The method as recited in claim 4, wherein said second set of semi-structured data is produced from an iterative model, wherein said visualization comprises multiple infographics displaying changes in said second set of semi-structured data produced during iterations of said iterative model.

7. The method as recited in claim 1 further comprising:
generating visualization scores used to identify visualizations by said model;
receiving feedback based on said identified visualizations;
updating said trait and constraint rule set based on said feedback; and
updating a visualization score based on said updated trait and constraint rule set.

8. A computer program product for generating visualizations for semi-structured data, the computer program product comprising one or more computer readable storage mediums having program code embodied therewith, the program code comprising programming instructions for:
extracting visualization data from infographics, wherein said visualization data comprises the following: traits of a first set of semi-structured data displayed in said infographics, characteristics of said infographics and constraints in displaying said first set of semi-structured data in said infographics;
generating a trait and constraint rule set from said extracted visualization data, wherein said trait and constraint rule set comprises said traits of said first set of semi-structured data and said constraints in displaying said first set of semi-structured data in said infographics; and
training a model to map semi-structured data to elements of infographics using said trait and constraint rule set and said characteristics of said infographics using association rule learning.

9. The computer program product as recited in claim 8, wherein said traits of said first set of semi-structured data comprise one or more of the following selected from the group consisting of: a label, a label type, a dimension, a data type, a distribution, and a range of data.

10. The computer program product as recited in claim 8, wherein the program code further comprises the programming instructions for:
generating a confusion matrix to provide a summary of prediction results from said model.

11. The computer program product as recited in claim 8, wherein the program code further comprises the programming instructions for:
receiving a second set of semi-structured data;
analyzing said second set of semi-structured data to identify characteristics of said second set of semi-structured data;
identifying a trait and constraint rule in said trait and constraint rule set based on said identified characteristics of said second set of semi-structured data;
generating a visualization score using said trained model based on said identified trait and constraint rule; and
identifying a visualization based on said visualization score.

12. The computer program product as recited in claim 11, wherein said visualization comprises a pre-defined order of visualized infographics.

13. The computer program product as recited in claim 11, wherein said second set of semi-structured data is produced from an iterative model, wherein said visualization comprises multiple infographics displaying changes in said second set of semi-structured data produced during iterations of said iterative model.

14. The computer program product as recited in claim 8, wherein the program code further comprises the programming instructions for:
generating visualization scores used to identify visualizations by said model;
receiving feedback based on said identified visualizations;
updating said trait and constraint rule set based on said feedback; and
updating a visualization score based on said updated trait and constraint rule set.

15. A system, comprising:
a memory for storing a computer program for generating visualizations for semi-structured data; and
a processor connected to said memory, wherein said processor is configured to execute program instructions of the computer program comprising:
extracting visualization data from infographics, wherein said visualization data comprises the following: traits of a first set of semi-structured data displayed in said infographics, characteristics of said infographics and constraints in displaying said first set of semi-structured data in said infographics;
generating a trait and constraint rule set from said extracted visualization data, wherein said trait and constraint rule set comprises said traits of said first set of semi-structured data and said constraints in displaying said first set of semi-structured data in said infographics; and
training a model to map semi-structured data to elements of infographics using said trait and constraint rule set and said characteristics of said infographics using association rule learning.

16. The system as recited in claim 15, wherein said traits of said first set of semi-structured data comprise one or more of the following selected from the group consisting of: a label, a label type, a dimension, a data type, a distribution, and a range of data.

17. The system as recited in claim 15, wherein the program instructions of the computer program further comprise:
generating a confusion matrix to provide a summary of prediction results from said model.

18. The system as recited in claim 15, wherein the program instructions of the computer program further comprise:
receiving a second set of semi-structured data;
analyzing said second set of semi-structured data to identify characteristics of said second set of semi-structured data;
identifying a trait and constraint rule in said trait and constraint rule set based on said identified characteristics of said second set of semi-structured data;
generating a visualization score using said trained model based on said identified trait and constraint rule; and
identifying a visualization based on said visualization score.

19. The system as recited in claim 18, wherein said visualization comprises a pre-defined order of visualized infographics.

20. The system as recited in claim 18, wherein said second set of semi-structured data is produced from an iterative model, wherein said visualization comprises multiple infographics displaying changes in said second set of semi-structured data produced during iterations of said iterative model.
